(19) United States
(12) Patent Application Publication
(10) Pub. No.: US 2014/0173546 A1
(43) Pub. Date: Jun. 19, 2014

(54) Method and system to view and analyze state model transition on host/semiconductor equipment for 300mm standards

(71) Applicant: Muthu Kumar, Chennai (IN)

(72) Inventor: Muthu Kumar, Chennai (IN)

(21) Appl. No.: 13/716,235

(22) Filed: Dec. 17, 2012

(51) Int. Cl. G06F 17/50

(52) U.S. Cl. CPC G06F 17/50
USPC 716/136

(57) ABSTRACT

The embodiments herein disclose a method and system to view and analyze state model transition on host/equipment for 300 mm standards. A state transition module is developed for effectively viewing and analyzing state model transition occurring on the host/equipment using 300 mm standards. The state transition module can be integrated with any host simulator software/equipment to validate the state machine. The transitions of state models can be viewed at runtime dynamically by reading the actual events from the network ports sent by the equipment/host. The method provides the user interface to know the state model transition including providing a statistical analysis of the job execution and the data collection events.

### TECHNICAL FIELD

The embodiments herein relate to semiconductor equipment and, more particularly, to viewing and analyzing state model transition in semiconductor equipment.

### BACKGROUND

Semiconductor manufacturing equipment (SME) is used in perhaps the most complex and advanced manufacturing process in the world, the production of semiconductor devices. The manufacturing process in semiconductor industries is very equipment intensive, requiring several types of tools or equipment to perform the manufacturing process. Semiconductors, such as microprocessors and memory devices, are used in a wide variety of manufactured products including personal computers, telecommunications equipment, and several common consumer electronics goods. The SME industry consists of two broad categories: front end and back end equipment. Front end SME is used to fabricate from a blank wafer to a completed wafer and create the semiconductor chips on the wafers. Back-end equipment is used to dicing the wafer into individual chips and all the processes thereafter; such as test, assembly and packaging.

Semiconductor device fabrication is the process used to create the integrated circuits (ICs) in electrical and electronic devices. This process is a multiple step sequence of photolithographic and chemical processing steps during which electronic circuits are gradually created on a wafer made of pure semiconducting material. The semiconductor industry strictly follows the Semiconductor Equipment and Materials International (SEMI) standards for all equipment that are manufactured for use in semiconductor fabrication units 300 mm standards comply with 300 mm wafer size and these standards allow the factory to control and monitor the equipment in a consistent way to implement automation. 300 mm standards such as E40, E90, E94, E87 and E116 enable IC manufacturers to communicate and automate wafer fabrication equipment in foundries or fabrication units.

Semiconductor equipment involves several steps to process the wafers and standards at every process which helps in understanding the states of hardware modules such as load port, aligner, wafer transporter, and inspection chamber. SEMI E87 defines the specification for Carrier Management (Load Port), E94 defines specification for control job management, E40 defines specification for process job management (wafer configuration), E90 defines the specification for substrate tracking (wafer transporter), and E116 defines the specification for performance tracking. Every standard has individual state machines that have to be examined during execution. The host or host simulator creates jobs to process the wafer on the equipment and the equipment sends several data collection events to the host or host simulator. These data collection events are associated with each standard that can be collected and validated from the host/equipment such as process job start, process job completed, process job aborted, control job started, cassette loaded and so on. These data collection events provide sufficient information and also follow a state model transition.

Generally, the user does not have a facility to monitor the state model transitions in a graphical form from the equipment or the host. The user has to view the logs to ascertain the reason for an unsuccessful process execution. Further, the data from these events are not parsed and available as data in the user interface for a graphical representation of state machines. Moreover, it is not possible to view the transitions dynamically. Most host simulator software products do not provide dynamical updates of state model transition and the logs have to be analyzed manually for the failure. The host simulator software do not provide user interface to know the status for the process jobs, control jobs, and the status of equipment performance. Further, there is no provision to enable the UI for message construction complying with E5 standard for E40, E94 and E87 related operations.

Currently, there exists no reusable software component framework available in the industry which can be directly used for viewing and analyzing the state model transition, which can be integrated with the equipment software or with host simulator software solution. There is a need for a system with a user interface to know the state model transition and which also assists in providing statistical analysis of the job execution process.

### BRIEF DESCRIPTION OF THE FIGURES

The embodiments herein will be better understood from the following detailed description with reference to the drawings, in which:

FIG. 1 is a block diagram depicting a framework of the state transition module in the semiconductor equipment, according to the embodiments as disclosed herein;

FIG. 2 is a block diagram depicting a framework of the state transition module in the controller, according to the embodiments as disclosed herein;

FIG. 3 is a block diagram depicting the architecture for 300 mm state transition framework, according to the embodiments as disclosed herein;

FIG. 4 is a sequence diagram detailing the transition state updating process, according to the embodiments as disclosed herein; and

FIG. 5 is a flow diagram detailing the transition state updating process, according to the embodiments as disclosed herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

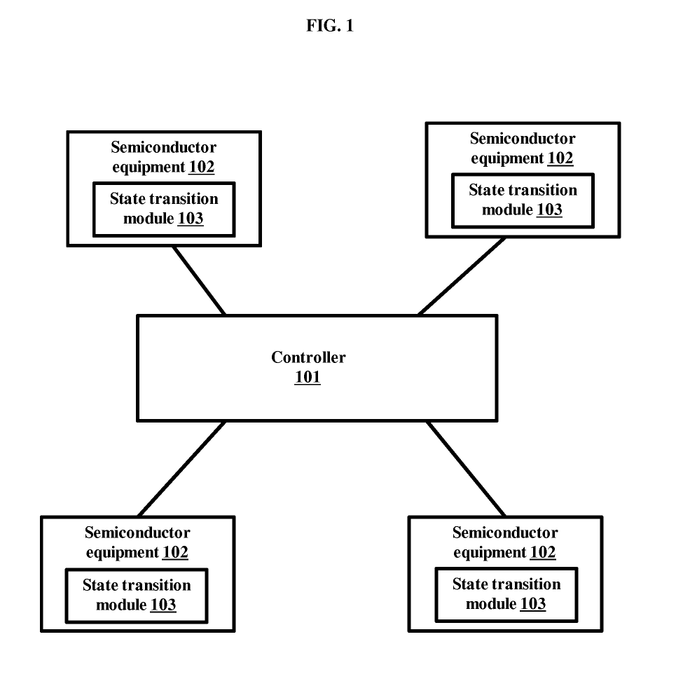

The embodiments herein disclose a method and system to view and analyze state model transition on host/equipment for 300 mm standards by developing a reusable component framework which effectively views and analyzes the state model transition occurring on the equipment/host. Referring now to the drawings, and more particularly to FIGS. 1 through 5, where similar reference characters denote corresponding features consistently throughout the figures, there are shown embodiments.

FIG. 1 is a block diagram depicting a framework of the state transition module in the semiconductor equipment, according to the embodiments as disclosed herein. As depicted in FIG. 1, the state model transition system is controlled by a controller 101. The controller 101 is host simulator software capable of monitoring and altering the operating conditions of the plurality of semiconductor equipments 102. The state transition module 103 is an integral part of the semiconductor equipment 102. The state transition module 103 may be directly used for viewing and analyzing the state model transition, which can be integrated with the semiconductor equipment 102 software or with the host simulator software.

This process of integration provides the user interface to be aware of the state model transition while also assists in providing a statistical analysis of the job execution.

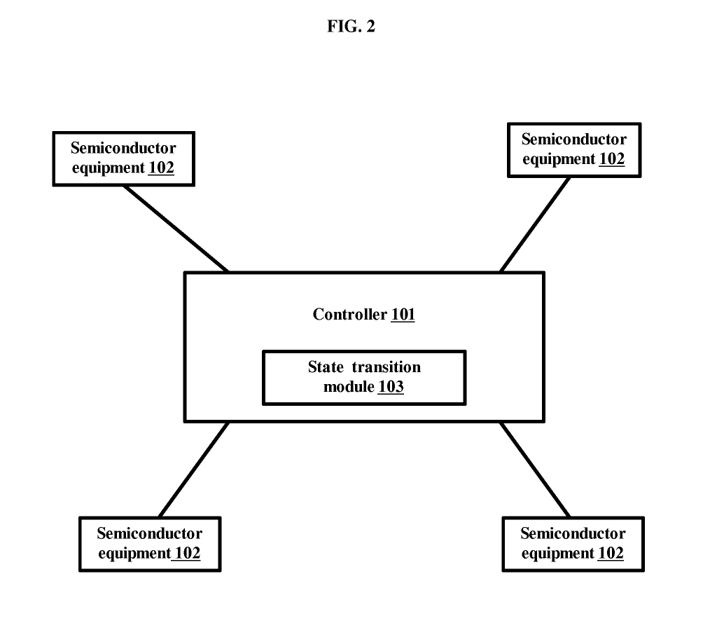

FIG. 2 is a block diagram depicting a framework of the state transition module in the controller, according to the embodiments as disclosed herein. From FIG. 2, it can be seen that state transition module 103 is an integral part of the controller 101. The state transition module 103 can be integrated within the controller 101 instead of each of the semiconductor equipment 102. Further, the state transition module 103 can be implemented on semiconductor equipment 102 or host simulator 101 to enable the user to identify issues by viewing the state model transition which also provides a statistical analysis of the data associated with the semiconductor manufacturing standards.

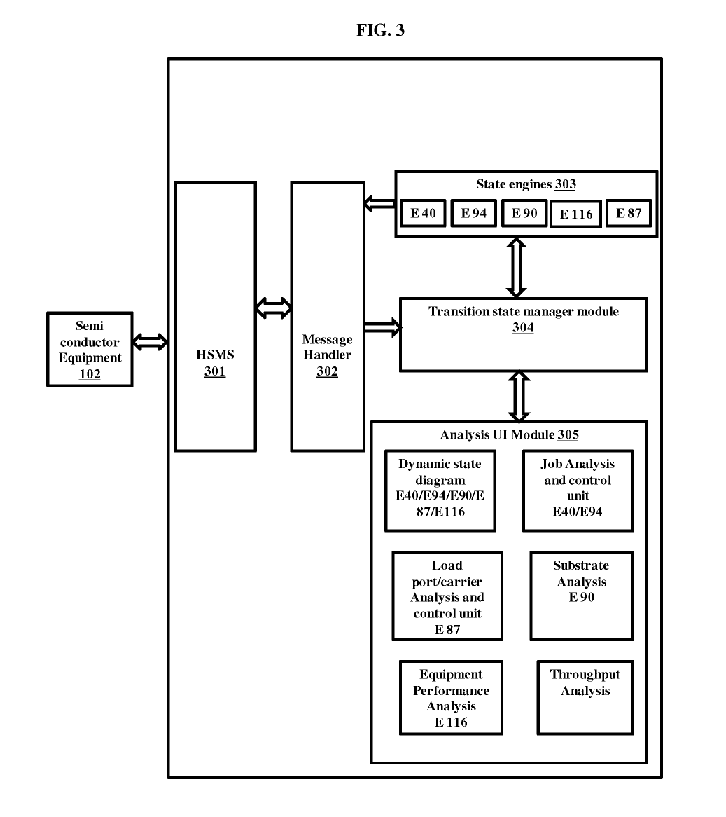

FIG. 3 is a block diagram depicting the architecture for 300 mm state transition framework, according to the embodiments, as disclosed herein. As depicted in FIG. 3, the state machine analyzer comprises of components, such as Message handler 302, State engines 303, transition state manager module 304, and analysis UI module 305. The HSMS 301 protocol is a standard transport protocol for communication between computers in semiconductor factories. The data collection events are received by the message handler 302 from HSMS 301. The Message Handler 302 parses the SECS messages and sends it to state machine analyzer which in turn sends to the respective E87/E40/E94/E90/E116 components in the state engines 303. Further, the transition state manager module 304 updates the respective state model's UI. The parsed data can be used for statistical analysis which will be updated in the respective UIs.

The state machine validation can be performed by using dynamic state machine diagram. The job analysis can be executed for E40 process job and E94 control job. Further, the control commands are used to execute E40/E94 operations. The load port analysis can be performed using E87 standard events which can also send control commands to execute E87 operations. Additionally, substrate analysis E90 and its locations (previous location and current location) can be determined. Furthermore, equipment performance analysis as per E116 events (like blocked or busy or idle) and throughput analysis can be performed. Throughput analysis may be performed by validating the time taken for the command and response and validating the parameters within certain time period.

By performing different types of analysis, the user need not know the intricacies of the state model and can easily convey the issue to the developer. Manual analysis of the logs can be avoided for a failed scenario(s). Also, since a UI is provided for sending commands to the semiconductor equipment 102/host, the user need not know the SECS message format.

The following table depicts the process job state transition.

TABLE 1

| S. No | Current state | Trigger | New State | Action |
|---|---|---|---|---|
| 1 | No state | The processing resource | QUEUED/POOLED | Job is placed at the Job |
| | | accepts a process job | | Queue |
| | | create request | | |
| 2 | QUEUED/POOLED | The processing resources | SETTING UP | Job is removed from the Job |
| | | has been allocated to the | | Queue. PRJob Setup Event is |
| | | Process Job | | triggered. |
| 3 | SETTING UP | Job material is present | Waiting for Start | PRJob Waiting for Start |
| | | AND the processing | | Event is triggered. |
| | | resources is ready to start | | |
| | | and the PR Process Start | | |
| | | Attribute is not set | | |
| 4 | SETTING UP | Material is present and | PROCESSING | PRJob Processing Event is |
| | | ready for processing. PR | | triggered. Material is |
| | | Process Start. Attribute is | | processed. |
| | | set | | |
| 5 | WAITING FOR | Job Start Directive | PROCESSING | PRJob processing event is |
| | START | | | triggered. Material is |
| | | | | processed |
| 6 | PROCESSING | Material processing | PROCESS | PRJob processing complete |
| | | complete | COMPLETE | event is triggered. The |
| | | | | processing resource performs |
| | | | | all required resource post- |
| | | | | conditioning. Await material |
| | | | | departure |
| 7 | PROCESS | Job material departed the | (no state) | PRJob complete event is |
| | COMPLETE | processing resource AND | | triggered. The process job |
| | | resource post- | | is deleted. |
| | | conditioning completed, | | |
| | | OR superceded by | | |
| | | another process job on | | |
| | | the same material. | | |
| 8 | EXECUTING | The processing resource | PAUSING | The processing resource |
| | | initiated a process pause | | Pauses at the first |
| | | action | | convenient time. |
| 9 | PAUSING | The processing resource | PAUSED | None. |
| | | paused the job | | |
| 10 | PAUSE | The processing resource | EXECUTING | The processing resource |
| | | resumed the job | | resumes the activity that |
| | | | | was paused |
| 11 | EXECUTING | The processing resource | STOPPING | The processing resource |
| | | initiated a process stop | | stops the current execution |
| | | action. | | activity at the first |
| | | | | convenient time. |
| 12 | PAUSE | The processing resource | STOPPING | The processing resource |
| | | initiated a process stop | | stops the current execution |
| | | action. | | activity at the first |
| | | | | convenient time. |
| 13 | EXECUTING | The processing resource | ABORTING | The processing resource |
| | | initiated a process abort | | terminates the current |
| | | action. | | execution activity |
| | | | | immediately. |
| 14 | STOPPING | The processing resource | ABORTING | The processing resource |
| | | initiated a process abort | | terminates |
| | | action. | | the current execution |
| | | | | activity immediately. |
| 15 | PAUSE | The processing resource | ABORTING | The processing resource |
| | | initiated a process abort | | terminates the current |
| | | action. | | execution activity |
| | | | | immediately. |
| 16 | ABORTING | The processing resource | (no state) | PRJob Complete Event is |
| | | abort procedure is | | triggered. The process |
| | | complete and for some | | job is deleted |
| | | processing equipment the | | |
| | | related substrates are | | |
| | | moved out as part of the | | |
| | | error recovery | | |
| 17 | STOPPING | The processing resource | (no state) | PRJob Complete Event is |
| | | stop procedure completed | | triggered. The process |
| | | | | job is deleted |
| 18 | QUEUED/POOLED | “CANCEL”, “ABORT”, OR | (no state) | Remove the process job |
| | | “STOP” command | | from the queue/pool PRJob |
| | | received. | | Complete Event is triggered. |
| | | | | Delete the process job |

The process job state transition comprises of three main stages which are executing, active and post active stages. Initially, the jobs are queued/pooled which indicates the processing resources have been allocated to the process job. During the executing stage, setting up, pre-processing and processing operations are performed. During the active stage, the operations include executing, stopping, pausing and aborting. The post active stages indicate whether the process is completed, aborted or stopped. In an embodiment, the protocol enabling 300 mm state transition may be Transmission Control Protocol (TCP) or Internet Protocol (IP) or any other suitable protocol which can enable this transition.

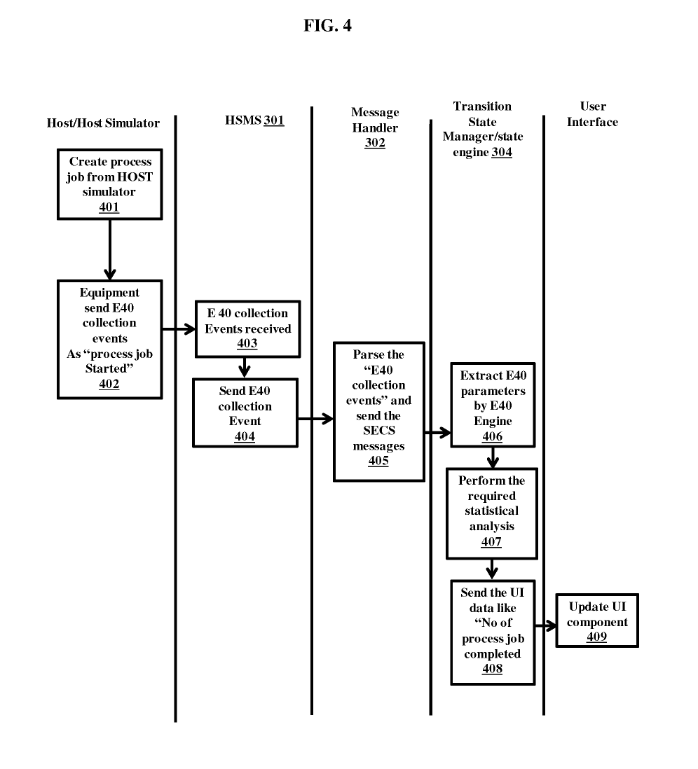

FIG. 4 is a sequence diagram detailing the transition state updating process, according to the embodiments as disclosed herein. As depicted in FIG. 4, initially the process job is created (401) from HOST simulator and the equipment sends (402) E40 collection events depicting it as “process job started”. Further, the HSMS 301 receives (403) E40 collection events and sends (404) the E40 collection events to the message handler 302. The message handler 302 parses (405) the E40 collection events. The transition state manager/state engine 304 extracts (406) E40 parameters by E40 engine and performs (407) the required statistical analysis. The UI data is sent (408) to the UI. Finally, the UI updates (409) UI components such as Dynamic state diagram, job analysis and control component, and throughput analysis component.

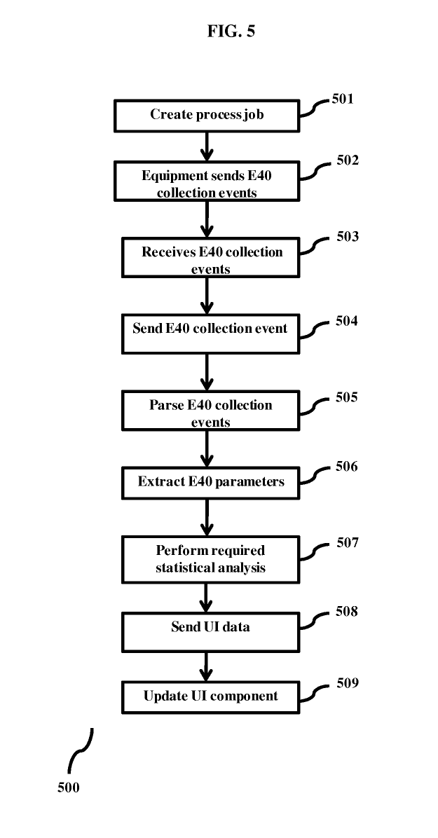

FIG. 5 is a flow diagram detailing the transition state updating process, according to the embodiments as disclosed herein. As depicted in FIG. 5, the host simulator creates (501) process job. A processing is instructed by Process Job (E40) and Control Job (E94). A processing instructed by Jobs begins when the following two conditions are satisfied.
1. Materials required for processing arrive at the semiconductor equipment 102.
2. Semiconductor equipment 102 resources required for a processing are available.

Further, the semiconductor equipment 102 sends (502) E40 collection events and the HSMS 301 receives (503) E40 collection events. The processing flow can be classified into two parts which comprises of Job creation and Job execution. The HSMS 301 sends (504) E40 collection events to the message handler 302 which parses (505) the E40 collection events and sends the SECS messages.

The transition state manager/state engine 304 extracts (506) E40 parameters by E40 engine and performs (507) the required statistical analysis of the data collection events. Then, the transition state manager/state engine 304 sends (508) the UI data (e.g. No. of process jobs completed) to the User interface which in turn updates (509) the UI components. The process flow can vary depending on the operational scenario or the equipment types. A typical process job create request form will comprise of parameters such as general information, recipe information, material information and so on. Once all the parameters are duly entered, the process job can be created . The various actions in method 500 may be performed in the order presented, in a different order or simultaneously. Further, in some embodiments, some actions listed in FIG. 5 may be omitted.

The embodiments disclosed herein can be implemented through at least one software program running on at least one hardware device and performing network management functions to control the network elements. The network elements shown in FIGS. 1a, 1b, and 2 include blocks which can be at least one of a hardware device, or a combination of hardware device and software module.

The embodiment disclosed herein specifies a system for viewing and analyzing the state model transition occurring on the equipment/host. The mechanism allows state machine validation, and can be used as a reusable framework which can be implemented on equipment as well as host simulator providing a system thereof. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of device which can be programmed including e.g. any kind of computer like a server or a personal computer, or the like, or any combination thereof, e.g. one processor and two FPGAs. The device may also include means which could be e.g. hardware means like e.g. an ASIC, or a combination of hardware and software means, e.g. an ASIC and an FPGA, or at least one microprocessor and at least one memory with software modules located therein. Thus, the means are at least one hardware means and/or at least one software means. The method embodiments described herein could be implemented in pure hardware or partly in hardware and partly in software. The device may also include only software means. Alternatively, the embodiment may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

1. A system for viewing and analyzing state model transition occurring on equipment for 300 mm standards, wherein said system comprises a High-Speed SECS Message Services (HSMS), a message handler, a transition state manager module, a state engine, an analysis user interface (UI) module, said system configured for:
create creating at least a process job by at least one of a HOST simulator and said equipment;
sending at least E40 collection events by said equipment to said High-Speed SECS Message Services;
sending at least standardized E40 collection events to said message handler by said High-Speed SECS Message Services;
parsing said standardized E40 collection events by said message handler;
extracting at least parameters of said E40 collection events by said state engine;
performing at least statistical analysis of said extracted parameters of said E40 collection events by said transition gate manager module;
sending user interface data to said analysis laser interface module by said transition state manager module; and
updating of components of a user interface by said analysis user interface module.

2. (canceled)

3. (canceled)

4. (canceled)

5. (canceled)

6. The system as in claim 1, wherein said analysis user interface module is configured to update components of said user interface, wherein said components comprise at least one of dynamic state diagram, job analysis and control, carrier analysis and control, substrate analysis, equipment performance analysis and throughput analysis.

7. A method to view and analyze state model transition occurring on equipment for 300 mm standards, wherein said method comprises:
creating at least a process job by at least one of a HOST simulator and said equipment;
sending at least E40 collection events by said equipment to a High-Speed SECS Message Services;
sending at least standardized E40 collection events to a message handler by said High-Speed SECS Message Services;
parsing said standardized E40 collection events by said message handler;
extracting at least parameters of said E40 collection events by a state engine;
performing at least statistical analysis of said extracted parameters of said E40 collection events by a transition state manager module;
sending user interface data to an analysis user interface module by said transition state manager module; and
updating components of a user interface by said analysis laser interface module.
